(19) United States
(12) Patent Application Publication
(10) Pub. No.: US 2020/0334587 A1
(43) Pub. Date: Oct. 22, 2020

(54) METHOD AND PROCESS FOR EFFICIENT USE OF GEOGRAPHICALLY DISPERSED FACILITIES

(71) Applicant: Indian Institute of Science (IISc), Bengaluru, Bangalore (IN)

(72) Inventors: Sanjeev Kumar Shrivastava, Bangalore (IN); Srinivasarao Ajjampur Shivashankar, Bangalore (IN); Navakanta Bhat, Bangalore (IN)

(73) Assignee: Indian Institute of Science (IISc), Bengaluru, Bangalore (IN)

(21) Appl. No.: 16/957,371

(22) PCT Filed: Dec. 24, 2018
(86) PCT No.: PCT/IN2018/050871

§ 371 Date: Jun. 23, 2020

(30) Foreign Application Priority Data
Jan. 2, 2018 (IN) 201841000140

(51) Int. Cl. G06Q 10/02; H04L 29/06; G06F 3/0482

(52) U.S. Cl. CPC G06Q 10/02; G06F 3/0482; H04L 65/1069; H04L 65/1073

(57) ABSTRACT

The invention discloses a system and method for a web-based reservation of geographically dispersed facilities. The system comprises a user registration unit configured to receive information to register a user and to provide an unique login ID to the user to generate a registered user, a user requisition unit configured to receive a requisition from the registered user to schedule a reservation for use of facilities, wherein the requisition from the registered user comprises at least one parameter selected from a date, a time slot, a location, and the facility, a centralized management unit configured to determine a list of available facility by comparing the requisition from the registered user to a database, a reservation display unit configured to present to the registered user the list of available facility along with details of the facility and receive from the registered user a selection of the facility sought by the registered user from the list of available facilities, wherein the details of the chosen facility comprises at least one of the following: location details, an available time for use, booking status, and the associated cost, and a reservation scheduling unit configured to schedule a reservation of the selected/desired facility based from the list of available facility made by the registered user. A method for web-based sharing and efficient use of at least one geographically dispersed facility is also described.

### FIELD OF THE INVENTION

The present invention relates to the field of web-based formation of local, regional, national networks of resources for their optimum use made possible by timely web-based access to them through reservation. The web-based network is optimized also to meet the requirements of the users of the resources in the network.

### BACKGROUND OF THE INVENTION

A variety of equipment and resources are acquired by organizations, such as academic institutions and research labs, which are geographically dispersed. However, these resources are not utilized efficiently because of lack of information about their existence and about their availability to the potential and needy users. Where publicly funded resources are involved, such lack of information often leads to duplication of resources, with concomitant avoidable expenditure from the exchequer.

CN103491652 provides for a system for optimum utilization of lab facilities in a single university campus or laboratory and provides algorithms for “collision avoidance”, etc., which ensure that the associated hardware/software work together to provide a user access to a desired resource in an orderly, assured manner. By implication, the invention concerns “self-service”, i.e., a user gains access to a desired facility so that the user can use it without the intervention of anyone else, such as the “owner” of the facility. Sophisticated hardware/software ensures the implementation of the above. However, the system does not provide for sharing of facilities installed in locations spread over a wide geography to enable optimization of facility utilization and meeting user needs.

CN206389406 provides for a system, which enables shared use of facilities, preventing duplication of facilities that wastes resources, etc. However, the description provided teaches that facilities are all situated in one location; that utilization and access are optimized through a network of facilities distributed in a geographically wide area.

Therefore, there is need for a web-based portal containing a database of resources, which will enable efficient and cost-effective use of available resources across geographies, narrow or wide. In particular, resources acquired with public funding must be available to everyone who needs them, as each one is an entitled stakeholder. In the absence of an efficient system that enables timely and assured access to the resources to needy users, duplication may occur, which results in inefficient deployment and waste of public expenditure.

### SUMMARY OF THE INVENTION

In an embodiment, the present invention discloses a system for web-based sharing and efficient use of geographically dispersed resources, which includes a user registration unit configured to receive information to register a user and to provide a unique login ID to the user to generate a registered user; a user requisition unit configured to receive a requisition from a registered user to schedule a reservation for use of a resource, wherein the requisition from the registered user comprises at least one parameter selected from a date, a time slot, a location, and a resource; a centralized management unit (CMU) configured to determine a list of available resources by comparing requisition from a registered user to the said database; a reservation display unit configured to present to the registered user the list of available resources, along with details of the resources, and receive from the registered user a selection of the resource desired by the registered user from the list of available resources, wherein the details of the resource sought by the registered user includes at least one of the following: location details, an available time for use, booking status, and the associated cost; and a reservation scheduling unit configured to schedule a reservation of the resource sought by the registered user.

In an embodiment, the present invention discloses a web-based method for reservation of resources. The method includes the steps of receiving information to register a user and providing a unique login ID to the user to generate a registered user; receiving a requisition from the registered user to schedule a reservation for the use of a resource, wherein the requisition from the registered user comprises at least one parameter selected from: a date, a time slot, a location, and a resource; determining a list of available resources by comparing the requisition from the registered user with the resources listed in the database; presenting to the registered user the list of available resources, along with details of each such resource, wherein details of the resource comprises at least one of: location details, available time-slots for its use, the booking status, and associated cost; receiving from the registered user a selection of the resource from the list of available resources; and, scheduling a reservation of the resource based on the selection of the resource made by the registered user from the list of available resources.

### BRIEF DESCRIPTION OF THE DRAWINGS

The foregoing and other features of embodiments of the present invention will become more apparent from the following detailed description of embodiments when read in conjunction with the accompanying drawings. In the drawings, like reference numerals refer to like elements.

FIG. 1: illustrates an exemplary system for web-based reservation of resources, in accordance with an embodiment of the invention.

FIG. 2: illustrates the block diagram of web-based method for reservation of resources, in accordance with an embodiment of the invention.

### DETAILED DESCRIPTION OF THE INVENTION

The invention is about sharing resources of all kinds, which are dispersed geographically, narrowly or widely, usually through the formation of regional networks of resources, so that an optimum choice can be made by a user.

In the following detailed description, reference is made to the accompanying drawings that form a part hereof, and in which are shown by way of illustration specific embodiments that may be practiced. These embodiments are described in sufficient detail to enable a person skilled in the art to practice the invention, and it is to be understood that other embodiments may be utilized and that logical, mechanical, and other changes may be made within the scope of the embodiments. Also, the words “comprising,” “having,” “containing,” and “including,” and other similar forms are intended to be equivalent in meaning and be open-ended in that an item or items following any one of these words is not meant to be an exhaustive listing of such item or items, or meant to be limited to only the listed item or items. The singular forms “a,” “an,” and “the” include plural references unless the context clearly dictates otherwise. The following detailed description is, therefore, not be taken as limiting the scope of the invention, but instead the invention is to be defined by the appended claims.

As used herein, the term “resource” could refer to a resource that has been procured using public funds, or set up by the government for the use of the public, or any resource that may be accessed by the public.

As used herein, the term “efficient use” could refer to increased duration for which the resource is in use, or a greater number of users of the resource, or greater number of applications where the resource is used.

As used herein, the term “use of a resource” could mean the use of a resource “on site”, or the use of a resource “remotely” from the site of the registered user.

The system and method may be implemented in a variety of computing systems. The computing systems that implement the described method(s) include, but are not limited to a server, a desktop personal computer, a notebook, a portable computer, hand-held devices, and a mainframe computer. Although the description herein is with reference to certain computing systems, the system and method may be implemented in other computing systems, though with a few variations, as will be understood by a person skilled in the art. It should be noted that the description and drawings merely illustrate the principles of the present subject matter. It will thus be appreciated that those skilled in the art will be able to envisage various arrangements that, although not explicitly described or shown herein, embody the principles of the present subject matter and are included within its spirit and scope.

In one embodiment of the present invention, the present invention overcomes the problems of the existing systems by creating a database that is accessible through a web portal. Through the web portal, a user can search for an available resource in a location nearest to the user, or the same or similar resource that is further away, but available sooner than a resource located nearer to the user.

In another embodiment of the present invention, the web portal of the invention enables reserving time on the resource (to make use of it), either through a payment gateway or on a bartering basis involving credits accumulated in the portal. In an embodiment, the invention enables the sharing of publicly funded resources, creating greater efficiency in their utilization and greater optimization of public expenditure. In yet another embodiment of the present invention, the invention also fosters collaboration across boundaries of geography and discipline. In another embodiment of the present invention, the system includes a database of experts who can be consulted to enable the effective use of resources.

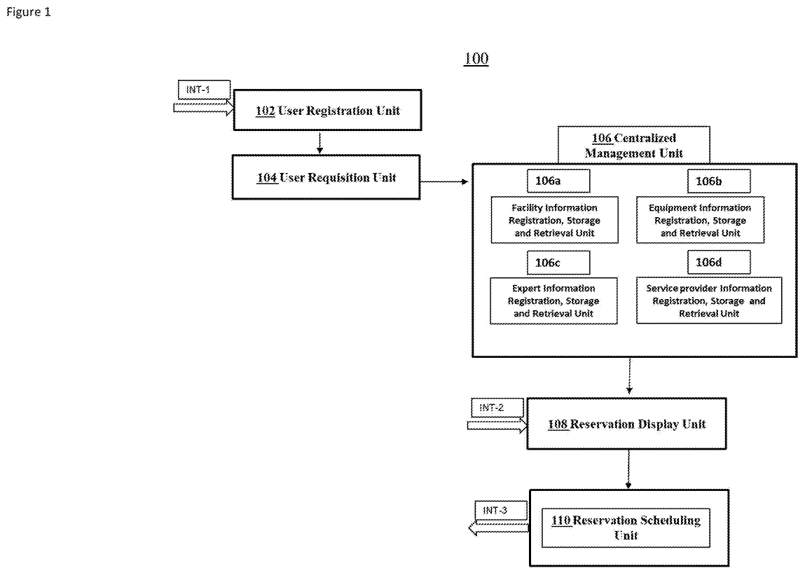

FIG. 1 illustrates an exemplary system (100) for web-based reservation of geographically dispersed resources, in accordance with an embodiment of the invention. The system comprises a user registration unit (102), a user requisition unit (104), a centralized management unit (106) and a reservation display unit (108) and a reservation-scheduling unit (110).

The user registration unit (102) is configured to receive information from a user for registration and to provide a unique user login ID. The user requisition unit (104) is configured to receive a user requisition to schedule a reservation for use of resource. The user requisition includes at least one parameter of the following: a date, a time slot, a location, and information about at least one resource.

The centralized management unit (106) is configured to determine one or more possible reservation options by comparing a user requisition to the database. As used herein, the “owner” may typically refer to the actual physical owner of the resource, or the manager of the resource, or the person in charge of the resource, or an agency that funds the resource. Centralized management unit further comprises a resource information registration unit, a storage unit and a retrieval unit 106a; and an equipment information registration unit, storage and retrieval unit 106b. In one embodiment of the present invention, the centralized management unit also comprises an expert information registration, storage and retrieval unit 106c, and a service provider registration, storage and retrieval unit 106d.

In an embodiment of the present invention, the database is established (and added to) when equipment and resources are registered on the portal by the respective owners.

In an embodiment of the present invention, the CMU is configured to hold the database of equipment and resources installed in various institutions that are custodians of the resources; the said database is populated and kept up-to-date by custodian institutions through designated representatives;

In an embodiment of the present invention, the centralized management unit configured to host a database of equipment/resources installed in various institutions that are geographically dispersed.

In one embodiment of the present invention, the reservation display unit (108) is configured to present to the registered user a list of reservation options along with resource details, and to receive from the user a selection from the list of reservation options, wherein the resource details include at least one of: a location detail, available time of use, booking status, and the cost of using the desired resource. The reservation-scheduling unit (110) is configured to schedule a reservation based on the selection made by the registered user.

In an embodiment of the present invention, the system can provide the list of reservation options, which is not based on global positioning system (GPS).

In an embodiment of the present invention, the owner of the resource may make a reservation for a certain resource for a certain period of time, in order to carry out maintenance or repairs. In an embodiment of the present invention, the owner of the resource may view the log of all the bookings of a resource for a certain period of time chosen by the owner, to know the extent of use, or the type of use of the resource, or any such performance parameter.

In an embodiment of the present invention, the owner may access the list of resources or the equipment, or the usage data, in order to understand the extent of use and availability of the resource, or to maintain and review an inventory of the resources. Such an inventory may be helpful in preventing the duplication of resources, thereby reducing wastage of resources.

In an embodiment of the present invention, the owner may, through the web-based system of the invention, sell or offer to transfer any resource owned by the owner, in case of the owners' inability to repair the resource if non-functional, or the owner's inability to pay for the routine running costs and maintenance costs of the resource. The owner may thus find a new owner for a resource, who can ensure the routine operation and upkeep of the resource.

In an embodiment of the present invention, the system further comprises of an expert information storage unit comprising at least one detail of an expert available to the registered user for consultation, if the registered user so desires. In an embodiment of the present invention, the expert-information storage unit further comprises a communication module configured to facilitate a real-time communication between the expert and the registered user regarding the request for support. As used herein, the term “support” may refer to consultation or technical advice. In an embodiment of the present invention, the expert-information storage unit comprises a user feedback unit configured to receive a feedback from the registered user and provide a ranking to the expert based on the feedback received.

In one embodiment of the present invention, the system may include a plurality of registered users, such as a first registered user, a second registered user, etc. In an embodiment of the present invention, the system further consists of a user-information storage unit including at least one detail of all registered users, which is available to the plurality of registered users for consultation. In an embodiment of the present invention, the user-information storage unit further comprises a communication module configured to facilitate a real-time communication among the plurality of registered users. In another embodiment of the present invention, such real-time communication assists a registered user in sharing information and expertise, thereby enhancing collaboration between geographically dispersed researchers and institutions.

In an embodiment of the present invention, the system further comprises “service provider information and communication unit (SPICU)” configured to store details of at least one provider of services required to maintain resources on the list. Through the SPICU, any owner of a resource is enabled to raise a request for support from at least one provider of service in case of a breakdown or a malfunctioning of the resource. As used herein, the term “support” may refer to consultation, supply of spares or parts, or repairs in case of a breakdown or malfunctioning of the resource.

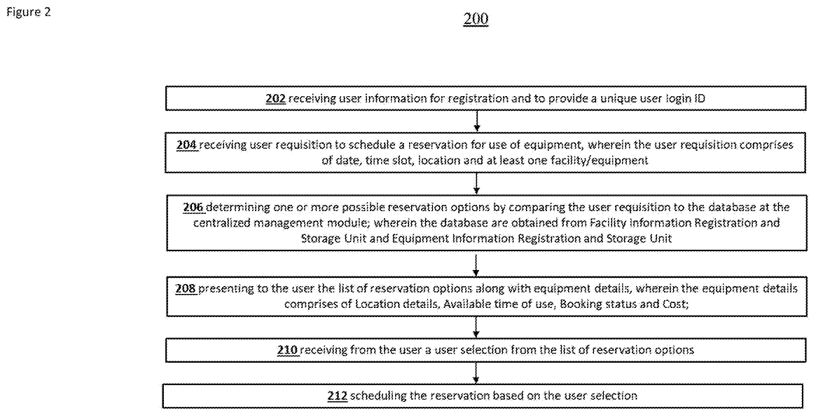

FIG. 2 illustrates the block diagram of the web-based method for reservation of geographically dispersed resources, in accordance with an embodiment of the invention. The method may be described in general context of computer-executable instructions. The computer-executable instructions may include, but are not limited to programs, routines, procedures, modules, functions, data structures and the like, which perform particular functions or implement particular types of abstract instructions.

In an embodiment, the present invention discloses a web-based method for reservation of geographically dispersed network of resources. The method comprises the steps of receiving user information for registration and providing a unique user login ID (202) via a user registration unit (102). The method also includes the steps of receiving user requisition to schedule a reservation for use of resource (204) via user requisition unit (104), wherein the user requisition comprises of at least one date, a time slot, a location and at least one resource in the network. Thereafter, one or more possible reservation options are determined by comparing the user requisition with the database (206) via the centralized management unit (106); wherein the database are obtained from the resource information registration and storage unit 106a and the equipment information registration and storage unit 106b. The list of reservation options along with resource details are presented to the registered user (208) via the reservation display unit (108), wherein the resource details comprise location details, time(s) during which it is available for use, booking status, and cost. The selection made by the user from the list of reservations available is received (210) by the reservation display unit (108). Thereafter, the reservation based on the user's selection (212) is made via reservation scheduling unit (110).

In an embodiment of the present invention, details of available reservations displayed to a registered user may depend on the user's geographical location.

In an embodiment of the present invention, details of available reservations displayed to a registered user may be ordered to show those that are available to the user the soonest.

In an embodiment of the present invention, details of available reservations displayed to a registered user may depend on the match between the requirements of the user and the technical specifications of the resource.

In an embodiment of the present invention, reservation details may be displayed based on the cost of using the resource sought by the registered user.

In an embodiment of the invention, the resources may include resources procured using public money, i.e., money provided by the government.

In an embodiment of the invention, the resources may include those procured by private entities, such as industries, private universities, privately owned colleges, non-government organizations, or other private entities.

### EXAMPLES

### Example 1

A web-based system for sharing research equipment: A web-based system for accessing research resources owned by various institutions in geographically dispersed locations is described. The system stores information about the various resources owned by the various institutions, for example microscopes, characterization equipment, testing equipment, etc. A user who has a need for these resources may register on the portal linked to this system, and become a registered user upon receiving a unique login ID. The registered user may then search the web-based system for a specific resource she or he needs to use, say Equipment A. The system then displays a list of locations where is Equipment A available, the detailed technical specifications of Equipment A at the different locations, the earliest time slot in which it is available at the various locations, the cost of using Equipment A at the various locations, etc. The registered user may make a selection based on the technical specifications listed, the proximity of the various locations listed, the earliest available time-slot, etc. The registered user has the option to make an advance online payment for the use of the selected resource. The registered user also can search, and obtain the contact details of an expert in the field of interest of the registered user. The registered user may then contact the expert for consultation, advice, etc.

The owner of the resource may obtain the contact details of a service provider of the resource of interest and may then contact the service provider to request support for sales or service of the resource of interest to the registered user. The registered user may also similarly obtain the contact details of a service provider of the resource of interest and may then contact the service provider to request support for sales or service of the resource of interest to the registered user.

### Example 2

A Web-based system for accessing hospitals/medical testing resources: Here, the web-based system may contain details of hospitals and medical testing resources available with hospitals, which are geographically dispersed. Examples of such resources may include magnetic resonance imaging (MRI), ultrasound scanning, blood tests, etc. A registered user requiring these resources, may search for, and reserve, these resources in a manner similar to Example 1 above. In addition, the registered user may also be able to contact a specialist doctor in the medical field of interest, for consultation or advice.

### Example 3

A web-based system for accessing public utilities: Here, the web-based system may include resources related to public utilities such as equipment related to electric power supply, equipment related to water supply, etc. Such equipment are typically owned by government bodies or other public agencies, which are responsible for providing and maintaining public utilities in a certain region. In this case, a registered user, who is such a government body/public agency, may search for and request the use of spare parts, such as transformers, pumps, and other such machinery that may be required for setting up and maintenance of such public utilities, in a manner similar to that described in Example 1.

The foregoing description of the preferred embodiment of the present invention has been presented for the purpose of illustration and description. It is not intended to be exhaustive or to limit the invention to the precise form disclosed. Furthermore, all examples recited herein are principally intended expressly to be only for pedagogical purposes to aid the reader in understanding the principles of the present subject matter and are to be construed as being without limitation to such specifically recited examples and conditions. Many modifications and variations are possible in light of the above teachings. It is intended that the scope of the present invention not be limited by this detailed description.

1. A system for web-based sharing and efficient use of at least one geographically dispersed resource, comprising
a user registration unit configured to receive information to register a user and to provide a unique login ID to the user to generate a registered user;
a user requisition unit configured to receive a requisition from the registered user to schedule a reservation for use of a resource, wherein the requisition from the registered user comprises at least one parameter selected from a date, a time slot, a location, and the resource;
a centralized management unit configured to determine a list of available resources by comparing the requisition from the registered user to a database;
a reservation display unit configured to present to the registered user the list of available resources, along with details of the resources; and to receive from the registered user a selection of the resource sought by the registered user from the list of available resources, wherein the details of the resource sought by the registered user comprise at least one of the following: location details, an available time for use, booking status, and the associated cost;
a reservation scheduling unit configured to schedule a reservation of the resource sought by the registered user based from the list of available resource made by the registered user.

2. The system as of claim 1, wherein the system further comprises of an expert information storage unit comprising at least one detail of an expert available to the registered user for consultation.

3. The system as of claim 2, wherein the registered user can contact the expert from the expert information storage unit and submit a request for support.

4. The system as of claim 2, wherein the expert information storage unit further comprises a communication module configured to facilitate real-time communication between the expert and the registered user regarding the request for support.

5. The system as of claim 2, wherein the expert information storage unit comprises a user feedback unit configured to receive feedback from the registered user and provide a ranking to the expert based on a feedback received from the registered user.

6. The system as of claim 1, wherein the system further comprises service provider information and communication unit configured to store details of at least one provider of services required to maintain resources on the list.

7. The system as of claim 6, wherein the registered user can raise a request with the at least one provider of service in case of a malfunctioning or breakdown of the resource.

8. A method for a web-based sharing and efficient use of at least one geographically dispersed resource, comprising the steps of:
receiving an information to register a user and to provide a unique login ID to the user to generate a registered user;
receiving a requisition from the registered user to schedule a reservation for the use of a resource, wherein the requisition from the registered user comprises at least one parameter selected from: a date, a time slot, a location, and the resource;
determining a list of available resources by comparing the requisition from the registered user with the resources listed in the database;
presenting to the registered user the list of available resources, along with details of each such resource, wherein details of the resource details comprises at least one of: location details, an available time of use, the booking status, and associated cost;
receiving from the registered user a selection of the resource from the list of available resources; and
scheduling a reservation of the resource based on the selection of the resource made by the registered user from the list of available resources.

9. The method as of claim 8, wherein the system further comprises a storage unit of information on experts for the registered user to contact, with at least one of an expert listed in the storage unit, enabling the registered user to submit a request for support.

10. The method as of claim 8, wherein the system further comprises an information and communication unit that lists providers of service to maintain resources, with at least one service provider listed, so that request for support can be made.
